(19) United States
(12) Patent Application Publication
(10) Pub. No.: US 2004/0054746 A1
(43) Pub. Date: Mar. 18, 2004

(54) Telephone directory information sharing system with mobile phone

(75) Inventor: Naoya Shibata, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/653,106

(22) Filed: Sep. 3, 2003

(30) Foreign Application Priority Data
Sep. 13, 2002 (JP) 2002-269262

(51) Int. Cl. G06F 15/16

(52) U.S. Cl. 709/207

(57) ABSTRACT

A telephone directory information sharing system used among a plurality of mobile phones. When a sending end newly registers or changes telephone directory information in his/her mobile phone, an e-mail program in the sender's mobile phone automatically transmits the telephone directory information as sharing information by e-mail to plural receivers. When receiving the e-mail message, a sharing control section in the receiver's mobile phone analyzes the e-mail message defined as the telephone directory information to be shared. Subsequently, a telephone directory information registering section in the receiver's mobile phone automatically registers the telephone directory information and updates the telephone directory. By this means, it becomes possible to easily share the telephone directory information among a plurality of mobile phones at a time without further installation of a special server.

### BACKGROUND OF THE INVENTION

The present invention relates to a telephone directory information sharing system for sending an e-mail message including telephone directory information to plural users on their mobile phones and PHSs (Personal Handyphone Systems) (hereinafter referred to as (a) mobile phones) each having a telephone directory function, e-mail transmitting and receiving function and the like so that they can share the information at a time.

### DESCRIPTION OF THE RELATED ART

Many users change mobile phones relatively in a short term. Most of them make a new contract with the contracting telephone carrier or with another carrier. When making a new contract, the user obtains a new telephone number and has to call his/her friends or acquaintances registered in the telephone directory one by one to tell them the new telephone number to ask them to update their telephone directories. Such procedure is troublesome and sometimes bothers the other party with his/her sudden call.

To solve the problems, there is disclosed in Japanese Patent Application Laid-Open Nos. 2000-196771 and 2002-057798 a system (method) for installing a server as a data center to manage telephone directory information of all mobile phone users. By this means, when a user registers a new telephone number or changes the existing number in the telephone directory, the server can reflect the changes on the telephone directory information used by the respective users. However, the installation of a server is expensive.

On the other hand, there is disclosed in Japanese Patent Application Laid-Open No. 2002-141998 a method for informing the other party of a new registered or a changed telephone number by using an e-mail exchange service on mobile phones without installing a server. E-mail is mainly intended to transmit and receive a text data and is transmitted to a certain person by designating his/her e-mail address. The receiver does not have to respond to the e-mail in real time unlike a phone call. Accordingly, prompt transmission can be realized without any trouble to the receiver. Moreover, the same message can be transmitted to plural specific users at a time by designating plural e-mail addresses.

Such advantages are introduced in a mobile phone capable of informing plural specified receivers of a new registered or a changed telephone number by e-mail to update their telephone directory information, which is disclosed in Japanese Patent Application Laid-Open No. 2002-135396.

The conventional mobile phone, which transmits and receives a telephone call by radio, comprises: a telephone directory means for registering a plurality of telephone directory data including at least a telephone number and a name and dialing a telephone number selected from the telephone directory data; an e-mail means for transmitting and receiving e-mail messages having at least character-coded text data to and from a party specified with his/her e-mail address; and a telephone directory registering means for, when the received e-mail includes telephone directory data having at least a telephone number in a predetermined format, registering the telephone directory data therein.

When a user changes his/her existing telephone number, he/she only sends a person a new telephone directory data in a predetermined format by e-mail so that the information in the telephone directory of the receiver's mobile phone can be updated. It is also possible to specify a plurality of receivers' e-mail addresses to update their telephone directories at a time. The new telephone number, etc. are automatically registered in the telephone directories of the receivers of the e-mail. Namely, the receivers do not have to waste time in receiving a telephone call for update and inputting a new telephone number on receipt of a postcard, FAX, etc. for update.

However in this prior art, the user has to specify the receivers one by one to transmit the e-mail message for update.

### SUMMARY OF THE INVENTION

It is therefore an object of the present invention to provide a telephone directory information sharing system in which new registered or changed telephone directory information can be shared among an arbitrary group(s) without installing a special server by the use of e-mail.

According to a first aspect of the present invention, for achieving the object mentioned above, there is provided a telephone directory information sharing system with a mobile phone that has an e-mail transmitting and receiving function and that manages telephone directory information including at least a name, telephone number, e-mail address and remark of a registered user, comprising:

an e-mail program for receiving an e-mail message and transmitting an e-mail message to at least one designated destination;

a telephone directory information registering section for managing telephone directory information that has been registered and newly registered or changed telephone directory information;

a telephone directory information processing section for processing the telephone directory information that has been registered in the telephone directory information registering section and the newly registered or changed telephone directory information for display and storage;

a user interface for accepting the telephone directory information input by a user and displaying the telephone directory information that has been registered; and

a sharing control section for composing an e-mail message to report the newly registered or changed telephone directory information as telephone directory information to be shared to at least one predetermined group, requesting the e-mail program to transmit the e-mail message, and analyzing the e-mail message when receiving the e-mail message reporting the telephone directory information to be shared.

According to a second aspect of the present invention, in the first aspect, to automatically transmit the e-mail message including the telephone directory information to be shared to users registered in the group:

the user interface accepts the telephone directory information to be shared input via an input device provided to the mobile phone and sends the telephone directory information to be shared to the telephone directory information processing section;

the telephone directory information processing section processes the telephone directory information to be shared for storage and sends the processed information to the telephone directory information registering section;

the telephone directory information registering section stores the telephone directory information to be shared and sends the information to the sharing control section;

at least one predetermined sharing group is selected to share the telephone directory information among users in the group;

the sharing control section composes an e-mail message including the telephone directory information to be shared in its text and requests the e-mail program to transmit the e-mail message; and

the e-mail program transmits the e-mail message.

According to a third aspect of the present invention, in the second aspect, a user at a sending end determines whether or not to share the telephone directory information.

According to a fourth aspect of the present invention, in the second aspect, a user at a sending end determines at least one sharing group.

According to a fifth aspect of the present invention, in the second aspect, the e-mail message is transmitted to plural users making use of at least one mailing list.

According to a sixth aspect of the present invention, in the first aspect, to automatically register in the telephone directory at a receiving end the telephone directory information that has been newly registered or changed in the telephone directory at a sending end when receiving the e-mail message including the telephone directory information to be shared:

the e-mail program sends the e-mail message to the sharing control section;

the sharing control section analyzes the received e-mail message;

the telephone directory information processing section processes the telephone directory information included in the e-mail message for storage;

the user interface displays the telephone directory information to be shared on a display and sends the information to the telephone directory information registering section;

a predetermined group in which the telephone directory information is to be registered is selected;

the telephone directory information registering section searches the selected group for telephone directory information corresponding to the received telephone directory information to be shared, checks whether the received telephone directory information is entirely or partially identical to the telephone directory information that has already been registered, registers or updates necessary telephone directory information, and sends the e-mail message including the telephone directory information processed for sharing back to the e-mail program; and

the e-mail program processes the e-mail message in the same manner as receiving a normal e-mail message.

According to a seventh aspect of the present invention, in the sixth aspect, a user at a receiving end determines whether or not to register the telephone directory information to be shared.

According to an eighth aspect of the present invention, in the sixth aspect, a user at a receiving end selects the group in which the telephone directory information is to be registered.

According to a ninth aspect of the present invention, in the sixth aspect, a user at a receiving end determines whether or not to update the telephone directory information.

According to a tenth aspect of the present invention, in the sixth aspect:

the mobile phone including the sharing control section transmits the e-mail message including the telephone directory information to be shared to a mobile phone and/or a terminal that are/is incapable of the automatic registration; and

the mobile phone and/or the terminal that are/is incapable of the automatic registration processes the received e-mail message in the same manner as receiving a normal e-mail message.

### BRIEF DESCRIPTION OF THE DRAWINGS

The objects and features of the present invention will become more apparent from the consideration of the following detailed description taken in conjunction with the accompanying drawings in which:

FIG. 1 is a diagram showing a configuration of a module of a mobile phone according to the present invention;

FIG. 2 is a flowchart when transmitting telephone directory information to be shared; and

FIG. 3 is a flowchart when receiving telephone directory information to be shared.

### DESCRIPTION OF THE PREFERRED EMBODIMENT

Referring now to the drawings, an embodiment of the present invention is explained in detail.

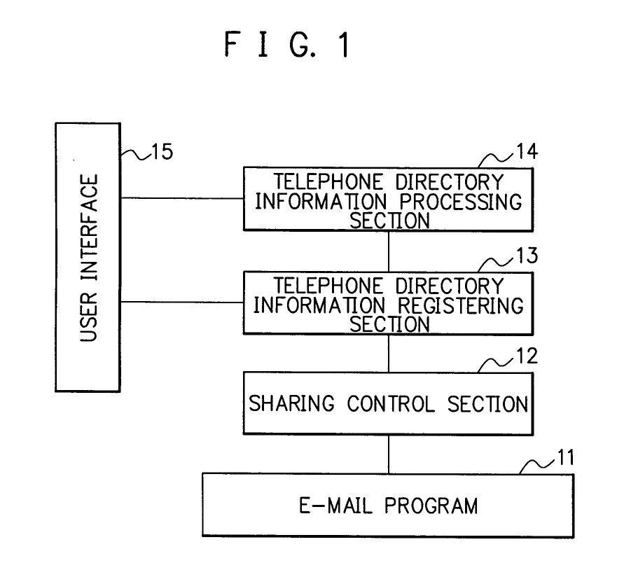

In reference to FIG. 1, the mobile phone according to the present invention comprises an e-mail program 11, a sharing control section 12, a telephone directory information registering section 13, a telephone directory information processing section 14 and a user interface 15.

The e-mail program 11 receives and transmits e-mail messages to a specified destination(s).

The sharing control section 12, at the time of e-mail transmission, composes an e-mail message including a new registered or updated (or deleted) telephone directory information according to directions from the telephone directory information registering section 13, and requests the e-mail program 11 to transmit the e-mail message. On the other hand, at the time of e-mail reception, the section 12 receives an e-mail message that is defined as telephone directory information to be shared. Afterwards, the section 12 analyzes the content of the e-mail message to identify the telephone directory information to be shared such as a registered name, a telephone number, e-mail address, a remark and/or the like. Subsequently, the section 12 sends the telephone directory information to the telephone directory information registering section 13. Furthermore, the section 12 keeps destination addresses such as mail addresses, mailing-list addresses and the like to which the telephone directory information to be shared is transmitted.

The telephone directory information registering section 13, at the time of e-mail transmission, keeps newly registered or updated telephone directory information received from the telephone directory information processing section 14 and directs the sharing control section 12 to share the information. On the other hand, at the time of e-mail reception, the section 13 compares the telephone directory information received from the sharing control section 12 with the telephone directory information that has already been registered to find any difference therebetween. If any, the section 13 updates the telephone directory information.

The telephone directory information processing section 14, at the time of e-mail reception, receives the registered telephone directory information from the telephone directory information registering section 13. Subsequently, the section 14 processes the received information for display and sends it to the user interface 15. On the other hand, at the time of e-mail transmission, the section 14 receives telephone directory information inputted by the user via the user interface 15. Subsequently, the section 14 processes the received information for registration and sends it to the telephone directory information registering section 13.

The user interface 15, at the time of reception, receives the registered telephone directory information from the telephone directory information processing section 14 according to directions inputted by the user via an input device provided to the mobile phone. Subsequently, the user interface 15 displays the received information on the display of the mobile phone. On the other hand, at the time of transmission, the user interface 15 receives from the input device newly registered or updated telephone directory information inputted by the user. Subsequently, the user interface 15 displays the received information on the display of the mobile phone, and sends it to the telephone directory information processing section 14.

In the following, an explanation will be given of an operation of the system of the present invention in reference to FIGS. 1, 2 and 3.

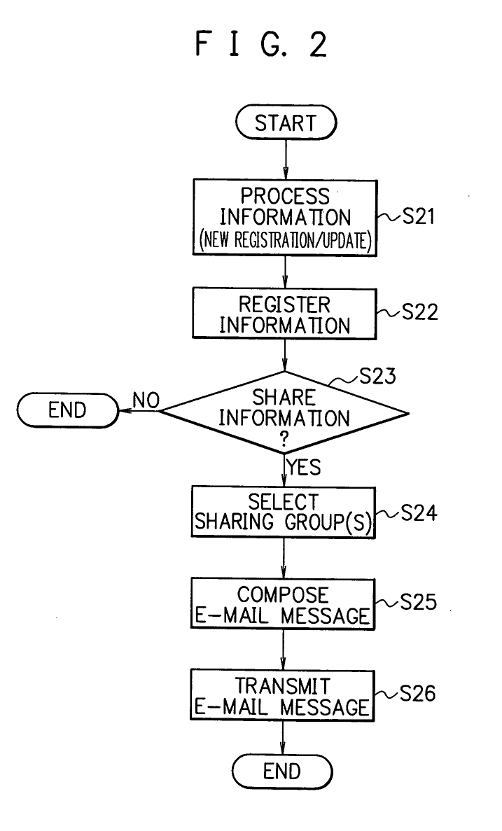

First, an explanation will be given of an operation of each section in the mobile phone of the present invention when registering new telephone directory information in reference to FIG. 2.

First, the user interface 15 accepts the input of telephone directory information to be newly registered such as a registration name, a telephone number, an e-mail address, a remark and the like from the input device provided to the mobile phone. Subsequently, the user interface 15 sends the information to the telephone directory information processing section 14.

When receiving the telephone directory information, the telephone directory information processing section 14 processes the information for storage and sends it to the telephone directory information registering section 13 (Step S21).

When receiving the processed information, the telephone directory information registering section 13 saves (registers) the information and sends it to the sharing control section 12 (Step S22).

Hereat, it is checked whether or not to share the newly registered telephone directory information by confirming a sharing setting (Step S23). When the sharing setting has not been made in advance (Step S23/No), the operation is finished. This means that the user updates only his/her telephone directory. On the other hand, when the sharing setting has been made in advance (Step S23/Yes), at least one predesignated sharing group or mailing list is automatically selected (Step S24) and the operation is carried on by the sharing control section 12.

It is also possible at Step S23 to let the user determine whether or not to share the newly registered telephone directory information. In this case, when the user determines to share the information, he/she may select at Step S24 at least one of sharing groups from the telephone directory wherein there are registered a plurality of destination addresses divided into plural groups.

Incidentally, the telephone directory may be managed such that the telephone directory information is classified into a plurality of groups, mailing lists, and the like. Accordingly, the user may select at least one group and/or mailing list to send an e-mail message to a plurality of receiving ends. By removing the registered user(s) to another group or mailing list and vice versa, the user can arbitrarily set the range of the group and easily select a plurality of destination addresses at a time. Incidentally, the user may select a single receiver or a plurality of receivers one by one from the telephone directory.

When receiving the newly registered information, the sharing control section 12 automatically composes an e-mail message including the received information in its text to request the e-mail program 11 to send the e-mail message (Step S25).

When receiving the request to send the e-mail message from the sharing control section 12, the e-mail program 11 transmits the e-mail message (Step S26).

Incidentally, each section operates in the same manner as described above when the telephone directory information is partially changed or completely deleted.

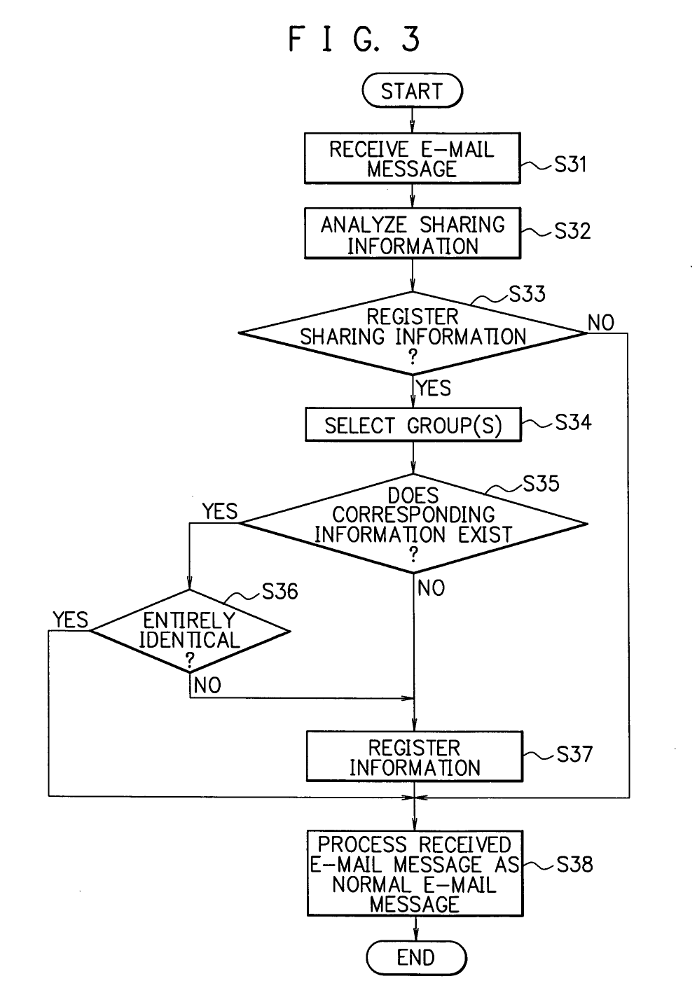

Next, an explanation will be given of an operation of each section in the mobile phone of the present invention when receiving e-mail message including the telephone directory information to be shared in reference to FIG. 3.

For example, when receiving the e-mail message reporting that the telephone directory information therein is to be shared, which is evident from its subject (Step S31), the e-mail program 11 sends the e-mail message to the sharing control section 12.

The sharing control section 12 analyzes the received e-mail message to retrieve the information therein (Step S32), and sends the retrieved information to the telephone directory information processing section 14. The section 14 processes the received information for storage. Subsequently, the user interface 15 displays the information on the display. Afterwards, the information is sent to the telephone directory information registering section 13.

Hereat, it is checked whether or not to register the telephone directory information by confirming a registration setting (Step S33). When the registration setting has not been made in advance (Step S33/No), the received e-mail message is processed in the same manner as receiving a normal e-mail message. On the other hand, when the registration setting has been made in advance (Step S33/Yes), a predesignated group or mailing list is automatically selected (Step S34) and the operation is carried on by the telephone directory registering section 13.

It is also possible at Step S33 to let the user determine whether or not to register the received telephone directory information. Furthermore, when the telephone directory is managed such that the respective telephone directory information is classified into plural groups, the user may select at Step S34 the group in which the received telephone directory information is to be registered.

When receiving the telephone directory information to be shared, the telephone directory information registering section 13 searches the selected group for the corresponding telephone directory information (Step S35). When the corresponding information has not been registered (Step S35/No), the section 13 registers therein the received telephone directory information as a new record (Step S37).

On the other hand, when the corresponding information has been registered (Step S35/Yes), the section 13 checks whether the received telephone directory information is entirely or partially identical to the telephone directory information that has already been registered (Step S36).

When the received telephone directory information is partially identical to the registered one (Step S36/No), the telephone directory information registering section 13 updates only the changed information and overwrites the telephone directory (Step S37). At Step S37, it is also possible to let the user determine whether or not to update the telephone directory information before overwriting.

On the other hand, when the received telephone directory information is entirely identical to the registered one (Step S36/Yes), the telephone directory information registering section 13 does not execute any processing to the received telephone directory information. The received e-mail message is processed as a normal e-mail message (Step S38).

Incidentally, when receiving e-mail message including a request to delete telephone directory information, the telephone directory information registering section 13 searches the telephone directory for the telephone directory information that is completely identical to the received one. When finding the same information, the section 13 deletes the information.

Afterwards, the telephone directory information registering section 13 sends the e-mail message that has been processed for sharing (registration/delete) back to the e-mail program 11. Subsequently, the e-mail program 11 processes the received e-mail message as a normal e-mail message (Step S38).

In this embodiment, both of the sending and receiving ends use the mobile phones having automatic registration functions to share the telephone directory information at a time. When a terminal that is not provided with automatic registration functions such as PC is used and receives an e-mail message for sharing, the terminal processes the e-mail message as a normal e-mail message.

As set forth hereinbefore, the present invention provides the following advantages.

First, telephone directory information can be easily shared among a plurality of users via their mobile phones. This is because the mobile phone of the present invention delivers newly registered or changed telephone directory information to be shared to receivers by e-mail. Further, a predetermined group(s) and/or mailing list(s) can be used to send an e-mail messages including telephone directory information to plural phones and/or terminals. Accordingly, it becomes possible to easily set the sharing range by changing the setting of the groups and mailing lists. User can arbitrarily select one or more groups and mailing lists when registering telephone directory information.

Secondly, telephone directory information can be shared among a plurality of receivers at a time. This is because when telephone directory information to be shared is newly registered or changed (updated), a mobile phone of the present invention delivers an e-mail message to plural receivers. Accordingly, it becomes possible to inform the receivers of the registered or changed telephone directory information at once.

Thirdly, it becomes possible to easily build a telephone directory information sharing system. This is because e-mail is used to deliver the registered or updated telephone directory information to be shared. Accordingly, there is no need to install a special server to store, manage and deliver the telephone directory information.

Fourthly, it becomes possible to have a back up of the telephone directory information. This is because the telephone directory information is exchanged by e-mail. The received or transmitted information is respectively left in an in-tray and out-tray in a mail box. Accordingly, the user can search the trays for information he/she wants at any time.

Fifthly, it becomes possible to make detailed setting for sharing. The sending end of an e-mail message can determine whether or not to share newly registered or changed (deleted) telephone directory information and can arbitrarily select one or more receivers or at least one sharing group and the like. On the other hand, the receiving end can determine a group in which the received telephone directory information is to be registered and can determine whether or not to update (overwrite) the corresponding telephone directory information that has been registered and the like. This is because the mobile phone of the present invention is provided with a function to let a user freely select a single or plural receivers by a group(s) or mailing list(s) from the telephone directory in addition to an automatic selection function.

Sixthly, when a user uses a terminal incapable of applying the telephone directory information sharing system of the present invention, the user can obtain newly registered or changed telephone directory information. For example, when a personal computer that is not provided with a function to automatically register telephone directory information to be shared receives an e-mail message, the PC processes the e-mail message in the same manner as receiving a normal e-mail message.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

What is claimed is:

1. A telephone directory information sharing system with a mobile phone that has an e-mail transmitting and receiving function and that manages telephone directory information including at least a name, telephone number, e-mail address and remark of a registered user, comprising:
an e-mail program for receiving an e-mail message and transmitting an e-mail message to at least one designated destination;
a telephone directory information registering section for managing telephone directory information that has been registered and newly registered or changed telephone directory information;
a telephone directory information processing section for processing the telephone directory information that has been registered in the telephone directory information registering section and the newly registered or changed telephone directory information for display and storage;
a user interface for accepting the telephone directory information input by a user and displaying the telephone directory information that has been registered; and
a sharing control section for composing an e-mail message to report the newly registered or changed telephone directory information as telephone directory information to be shared to at least one predetermined group, requesting the e-mail program to transmit the e-mail message, and analyzing the e-mail message when receiving the e-mail message reporting the telephone directory information to be shared.

2. A telephone directory information sharing system with a mobile phone as claimed in claim 1, wherein, to automatically transmit the e-mail message including the telephone directory information to be shared to users registered in the group:
the user interface accepts the telephone directory information to be shared input via an input device provided to the mobile phone and sends the telephone directory information to be shared to the telephone directory information processing section;
the telephone directory information processing section processes the telephone directory information to be shared for storage and sends the processed information to the telephone directory information registering section;
the telephone directory information registering section stores the telephone directory information to be shared and sends the information to the sharing control section;
at least one predetermined sharing group is selected to share the telephone directory information among users in the group;
the sharing control section composes an e-mail message including the telephone directory information to be shared in its text and requests the e-mail program to transmit the e-mail message; and
the e-mail program transmits the e-mail message.

3. A telephone directory information sharing system with a mobile phone that has an e-mail transmitting and receiving function and that manages telephone directory information including at least a name, telephone number, e-mail address and remark of a registered user, comprising:
an e-mail program for receiving an e-mail message and transmitting an e-mail message to at least one designated destination;
a telephone directory information registering section for managing telephone directory information that has been registered and newly registered or changed telephone directory information;
a telephone directory information processing section for processing the telephone directory information that has been registered in the telephone directory information registering section and the newly registered or changed telephone directory information for display and storage;
a user interface for accepting the telephone directory information input by a user and displaying the telephone directory information that has been registered; and
a sharing control section for composing an e-mail message to report the newly registered or changed telephone directory information as telephone directory information to be shared to at least one predetermined group, requesting the e-mail program to transmit the e-mail message, and analyzing the e-mail message when receiving the e-mail message reporting the telephone directory information to be shared; wherein, to automatically transmit the e-mail message including the telephone directory information to be shared to users registered in the group:
the user interface accepts the telephone directory information to be shared input via an input device provided to the mobile phone and sends the telephone directory information to be shared to the telephone directory information processing section;
the telephone directory information processing section processes the telephone directory information to be shared for storage and sends the processed information to the telephone directory information registering section;
the telephone directory information registering section stores the telephone directory information to be shared and sends the information to the sharing control section;
at least one predetermined sharing group is selected to share the telephone directory information among users in the group;
the sharing control section composes an e-mail message including the telephone directory information to be shared in its text and requests the e-mail program to transmit the e-mail message; and
the e-mail program transmits the e-mail message.

4. A telephone directory information sharing system with a mobile phone as claimed in claim 3, wherein a user at a sending end determines whether or not to share the telephone directory information.

5. A telephone directory information sharing system with a mobile phone as claimed in claim 3, wherein a user at a sending end determines at least one sharing group.

6. A telephone directory information sharing system with a mobile phone as claimed in claim 3, wherein the e-mail message is transmitted on the basis of at least one mailing list.

7. A telephone directory information sharing system as claimed in claim 1, wherein, to automatically register in the telephone directory at a receiving end the telephone directory information that has been newly registered or changed in the telephone directory at a sending end when receiving the e-mail message including the telephone directory information to be shared:
the e-mail program sends the e-mail message to the sharing control section;
the sharing control section analyzes the received e-mail message;
the telephone directory information processing section processes the telephone directory information included in the e-mail message for storage;
the user interface displays the telephone directory information to be shared on a display and sends the information to the telephone directory information registering section;
a predetermined group in which the telephone directory information is to be registered is selected;
the telephone directory information registering section searches the selected group for telephone directory information corresponding to the received telephone directory information to be shared, checks whether the received telephone directory information is entirely or partially identical to the telephone directory information that has already been registered, registers or updates necessary telephone directory information, and sends the e-mail message including the telephone directory information processed for sharing back to the e-mail program; and
the e-mail program processes the e-mail message in the same manner as receiving a normal e-mail message.

8. A telephone directory information sharing system with a mobile phone that has an e-mail transmitting and receiving function and that manages telephone directory information including at least a name, telephone number, e-mail address and remark of a registered user, comprising:
an e-mail program for receiving an e-mail message and transmitting an e-mail message to at least one designated destination;
a telephone directory information registering section for managing telephone directory information that has been registered and newly registered or changed telephone directory information;
a telephone directory information processing section for processing the telephone directory information that has been registered in the telephone directory information registering section and the newly registered or changed telephone directory information for display and storage;
a user interface for accepting the telephone directory information input by a user and displaying the telephone directory information that has been registered; and
a sharing control section for composing an e-mail message to report the newly registered or changed telephone directory information as telephone directory information to be shared to at least one predetermined group, requesting the e-mail program to transmit the e-mail message, and analyzing the e-mail message when receiving the e-mail message reporting the telephone directory information to be shared; wherein, to automatically register in the telephone directory at a receiving end the telephone directory information that has been newly registered or changed in the telephone directory at a sending end when receiving the e-mail message including the telephone directory information to be shared:
the e-mail program sends the e-mail message to the sharing control section;
the sharing control section analyzes the received e-mail message;
the telephone directory information processing section processes the telephone directory information included in the e-mail message for storage;
the user interface displays the telephone directory information to be shared on a display and sends the information to the telephone directory information registering section;
a predetermined group in which the telephone directory information is to be registered is selected;
the telephone directory information registering section searches the selected group for telephone directory information corresponding to the received telephone directory information to be shared, checks whether the received telephone directory information is entirely or partially identical to the telephone directory information that has already been registered, registers or updates necessary telephone directory information, and sends the e-mail message including the telephone directory information processed for sharing back to the e-mail program; and
the e-mail program processes the e-mail message in the same manner as receiving a normal e-mail message.

9. A telephone directory information sharing system with a mobile phone as claimed in claim 8, wherein a user at a receiving end determines whether or not to register the telephone directory information to be shared.

10. A telephone directory information sharing system with a mobile phone as claimed in claim 8, wherein a user at a receiving end selects the group in which the telephone directory information is to be registered.

11. A telephone directory information sharing system with a mobile phone as claimed in claim 8, wherein a user at a receiving end determines whether or not to update the telephone directory information.

12. A telephone directory information sharing system with a mobile phone as claimed in claim 8, wherein:
the mobile phone including the sharing control section transmits the e-mail message including the telephone directory information to be shared to a mobile phone and/or a terminal that are/is incapable of the automatic registration; and
the mobile phone and/or the terminal that are/is incapable of the automatic registration processes the received e-mail message in the same manner as receiving a normal e-mail message.
